(19) United States
(12) Patent Application Publication
(10) Pub. No.: US 2006/0233314 A1
(43) Pub. Date: Oct. 19, 2006

(54) Communication system and method

(76) Inventors: Christopher Tofts, Bristol (GB); Richard Taylor, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/389,503

(22) Filed: Mar. 27, 2006

(30) Foreign Application Priority Data
Mar. 29, 2005 (GB) 0506194.0

(51) Int. Cl. H04M 1/24

(52) U.S. Cl. 379/21

(57) ABSTRACT

Embodiments of the present invention relate to a communication system comprising means to process identification data associated with a communication; and means, responsive to the identification data, to access a data base to invoke at least one voice application arranged for providing assistance in relation to a respective fault; the data base having been configured to comprise the at least one voice application related to the respective fault.

### RELATED APPLICATIONS

The present application is based on, and claims priority from, United Kingdom Application Number 0506194.0, filed Mar. 29, 2005, the disclosure of which is hereby incorporated by reference herein in its entirety.

### FIELD

The present invention relates to a communication system and method.

### BACKGROUND

Communication systems or computer aided telephony systems are examples of data-processing systems in which a series of automated voice menus prompt a caller or user to press selective keys on their telephone to achieve a number of purposes. For example, the purposes may be to obtain banking services or other financial services, billing queries, assistance or other support services.

A caller is usually presented with a number of fixed voice menu options presented by a voice application that represents a first layer of options in a tree of voice menu options that, by appropriate selection, will lead the caller to the required assistance or other service automatically, that is, without human intervention. In essence, each layer of voice menu options aims to discover in a progressive manner a caller's intention. Alternatively, the various layers of voice menu options may lead the caller to a human assistant, which has the advantage of providing the human assistant with information relating to the caller's intention or reason for the call in preparation for meeting the caller's needs.

It will be appreciated that in either circumstance the voice menu options presented are fixed, that is, a standard voice application is created to deal with all queries regardless of any a priori knowledge. It will be appreciated that traversing such a standard voice application can be time-consuming and even frustrating for the caller. Furthermore, it will be appreciated that a call centre or system responsible for supporting users or callers can become overloaded with calls if a fault occurs that has a widespread impact. For example, a fault might occur that affects a large class of users or callers. Such a large class of callers or users would place significant strain on the resources of the call centre or system responsible for providing support or assistance.

It is an object of embodiments of the present invention to at least mitigate one or more of the problems of the prior art.

### SUMMARY

Accordingly, embodiments of the present invention provide a communication system comprising means to process identification data associated with a communication; and means, responsive to the identification data, to access a data base to invoke at least one voice application arranged for providing assistance in relation to a respective fault; the data base having been configured to comprise the at least one voice application in response to the respective fault.

Advantageously, it will be appreciated that the time taken to address a caller's likely reason for calling can be reduced by attempting to anticipate a caller's reason for calling in light of prevailing knowledge of at least one known fault. Furthermore, the caller can be informed of the fault and that it is known to the provider of support services.

Embodiments provide a communication system in which the data base is configured to comprise the voice application in response to a known fault associated with at least one program accessible by equipment such that the voice application provides support in relation to the respective fault. Suitably, prior knowledge of a fault or faults associated with a program used, or accessible, by the caller can reasonably be expected to be the caller's motivation for calling. Therefore, configuring or constructing a voice application comprising an entry or entries relating to a known problem or problems such as, for example, a known problem or problems of a program or programs might further reduce the time taken for a caller to be directed to appropriate assistance.

Many support services of companies or other enterprises are available via a telephone number known as, for example, a helpline. Accordingly, embodiments provide a communication system in which the communication is a telephone call. In such circumstances, the identification data comprises at least one of Calling Line Identification Number (CLID), Dialed Number Identification Service attribute values (DNIS), Calling Number Identification (CNI) or any other telephony identification data or identification data associated with the user or equipment or programs accessible to, or used by, the user.

Other companies or enterprises are known to provide assistance via a communication network such as, for example, the Internet. Therefore, embodiments provide a communication system in which the communication comprises a data communication having at least one data packet. The at least one data packet may comprise the identification data. It will be appreciated that the identification data might comprise network data such as, for example, an Internet Protocol address or other address or data that can be associated uniquely with a caller, their equipment, or software.

A voice application may comprise a single menu option or a number of menu options. The single menu option, in embodiments of the present invention, can relate to a corresponding problem associated with, for example, a program known to be used, or accessible, by the caller. Suitably, embodiments provide a communication system in which the at least one voice application comprises at least one menu option associated with the respective fault.

Embodiments can be realised in which, for example, a program, service or equipment is known to have a number of associated issues. Accordingly, embodiments provide a communication system in which the at least one voice application comprises a plurality of menu options associated with respective faults of a plurality of faults including the respective fault.

A caller, typically, has access to and uses more than one program, item of equipment, program or service. Therefore, embodiments provide a communication system in which the at least one voice application comprises a plurality of menu options; each option being associated with a respective fault of a plurality of faults including the respective fault. Each of the menu options can be associated with a fault of a respective program of the, or a selected number of, programs accessible to the caller.

Embodiments can be realised that provide a communication system comprising a plurality of voice applications each comprising a respective menu option such that each voice application is associated with a respective fault of a plurality of faults including the respective fault.

It will be appreciated by one skilled in the art that appropriate research would be useful in tailoring the voice applications in anticipation of a caller's requirements. Accordingly, embodiments provide a data processing method comprising creating, in at least one voice application, at least one menu option associated with at least one known fault; associating user identification data with the voice application to access the voice application in response to receiving the identification data; the user identification data being derived from communication data associated with the user.

Embodiments provide a data processing method comprising configuring the voice application such that the at least one menu option relates to the known fault and in which the known fault is associated with a program, item of equipment or service associated with a user.

Embodiments provide a data processing method comprising creating the at least one menu option such that it comprises data relating to instructions to effect a predetermined action to obtain assistance in relation to the at least one known fault.

Embodiments provide a data processing method in which creating the at least one menu option comprises creating a plurality of menu options such that each menu option of the plurality of menu options relates to a respective known fault of a plurality of known faults.

Embodiments provide a data processing method in which creating, in at least one voice application, at least one menu option comprises configuring a plurality of voice applications associated with at least one respective fault of a plurality of known faults associated with the at least one program.

Embodiments can be realised in which the at least one fault or faults is or are associated with at least one of a program used or accessible by a user or caller, an item of equipment used by a caller or user or a service associated with the user or caller.

It will be appreciated that embodiments of the present invention can be realised in the form of hardware, software or a combination of hardware and software. Any such software can be stored via a number of mediums such as magnetic or optically readable discs, chips, memory cards, memory sticks or any other volatile or non-volatile medium. Accordingly, embodiments provide a computer program comprising code to implement a system or method described herein. Embodiments also provide computer readable storage storing such a computer program.

### BRIEF DESCRIPTION OF THE DRAWINGS

Embodiments of the present invention will now be described, by way of example only, with reference to the accompanying drawings in which:

FIG. 1 shows a first communication arrangement comprising a communication system according to an embodiment;

FIG. 2 shows a second communication arrangement comprising a communication system according to a second embodiment;

FIG. 3 shows a pair of flow charts relating to the operation of the embodiments;

FIG. 4 illustrates a flow chart for fault notification; and

FIG. 5 depicts a fault restoration notification flow chart.

### DETAILED DESCRIPTION OF EMBODIMENTS

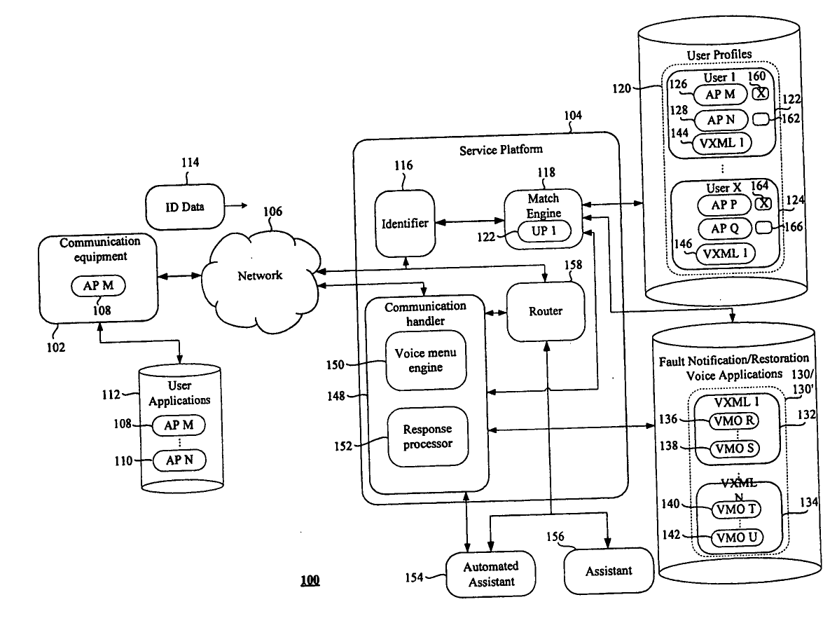

Referring to FIG. 1, there is shown a communication arrangement 100 in which a user (not shown) communicates, using communication equipment 102, with a service platform 104 via a communication network 106.

The user equipment 102 allows the user access to a number of applications 108 to 110 stored on, for example, an HDD 112. The user equipment 102 is illustrated as executing a first application 108. The user equipment can be, for example, a computer, a telephone, fax machine or any other communication equipment. The user equipment can be used to access at least one service in addition to or as an alternative to at least one application such as at least one of the applications 108 to 110.

The user of the communication equipment 102 can obtain assistance relating to any or all of the applications 108 to 110 or services accessible to the user of that equipment 102. To obtain any such assistance, the communication equipment 102 is used to establish a communication with the service platform 104. Identification data 114 that uniquely identifies at least one of the user and the communication equipment 102 or, preferably, both, is transmitted to the service platform 104 as part of the communication set up protocol. However, any such identification data 114 could be transmitted to the service platform 104 at some other convenient time.

The service platform 104 comprises an identifier 116 that extracts the identification data 114 from any communication with the communication equipment 102. The identifier 116 forwards the identification data 114, or data derived therefrom, to a match engine 118 that uses the identification data 114 to retrieve, from a user profiles database 120, the user profile associated with the identification data 114 and, in turn, with the communication equipment 102 or user. It will be appreciated that the match engine 118 is shown as having retrieved or identified a match between the identification data 114 and a user profile 122 stored within the user profiles database 120.

The user profiles database 120 is shown as comprising at least one user profile such as the user profile 122 matching the identification data 114. It will also be appreciated that a second or further user profile 124, corresponding to a different user, is also illustrated. The user profiles database 120 may comprise any convenient number of user profiles.

Each user profile is arranged to contain an indication of the applications or services accessible by the communication equipment 102. Taking the first user profile 122 as an example, it can be appreciated that it contains data 126 and 128 respectively identifying the applications 108 to 110 accessible or used by the communication equipment 102. Therefore, in response to a communication from the equipment 102, it is reasonable to assume that any such communication is related to one of the applications 108 to 110. Alternatively, or additionally, the data 126 and 128 might relate to one or more services associated with the user. In such circumstances, in response to a communication, it may be reasonable to assume that the communication is related to the one or more services.

The match engine 118, in light of the above assumption, also has access to a voice applications database 130 that contains a number of voice applications 132 to 134. The voice applications database 130 may comprise one voice application or more than one voice application according to requirements even though two voice applications 132 and 134 are illustrated. Each voice application 132 to 134 comprises a number of voice menu options such as one menu option or more than one menu option. For example, the first voice application 132 is illustrated as comprising voice menu options 136 to 138 but can comprise any convenient or appropriate number of menu options according to known problems or anticipated needs of a user. Similarly, the other voice application 134 also comprises a number of voice menu options 140 to 142. Each voice application 132 to 134 has been illustrated as comprising respective pairs of voice menu options. However, each voice application 132 to 134 can comprise any appropriate or convenient number of voice menu options.

Each voice application 132 to 134 is arranged to correspond to a respective user profile. It can be appreciated that each user profile 122 to 124 comprises an indication 144 to 146 of a respective voice application. The voice application indications 144 to 146 are used by the match engine 118 as an index to retrieve an appropriate voice application from the voice applications database 130.

The voice menu options can be expressed in many forms such as, for example, text, for processing by a text-to-speech engine, or digitised speech. The voice application menu options are used to output data as part of an interaction with the user via the communication equipment 102 in an attempt to determine the user's reason for establishing the communication. Each voice menu option is associated with a respective known fault. The known fault might be associated with an application of the applications 108 to 110 or a service accessible via the communication equipment 102. Therefore, by tailoring the voice applications 132 to 134 according to the contents of the user profiles 122 to 124, the user should have a more focused interaction with the service platform 104, that is, the user will be presented with voice menu options that are potentially more relevant to the user than voice menu options presented by a more generic voice application of, or voice interface to, the service platform 104. In effect, the user will be presented with one or more menu options or one or more voice applications relating to one or more known faults. In particular embodiments, the known faults will be those associated with at least one program, service or item of equipment associated with the user.

An embodiment can be realised in which a voice application is constructed not only in light of the known problem or problems but also in light of known issues associated with one or more of the applications 108 to 110. For example, application 108 may have a known fault. Therefore, the first voice application 132 associated with the first user profile 122 corresponding to the user of the communication equipment 102 or the communication equipment 102 itself may comprise a voice menu option relating to that fault or any other fault. It will be appreciated by one skilled in the art that further tailoring the voice applications in such a manner may lead to the service platform 104 being able to provide the user with assistance or being able to direct the user to assistance in a more focused manner.

Having identified a voice application such as the first voice application 132 as being relevant to an incoming or established communication, the voice application 132 is forwarded to a communication handler 148. The communication handler 148 is responsible for managing the exchange or communication between the user of the communication equipment 102 and the voice application. In essence, the communication handler 148 is responsible for executing or interpreting, or at least overseeing the execution or interpreting, of the voice application 132. It will be appreciated that executing or interpreting the voice applications are mere examples of actions that can be generally described as invoking or launching.

The communication handler 148 comprises a voice menu engine 150 responsible for outputting audible data representing digitised speech according to the voice menu options contained within a voice application currently being processed.

The communication handler 148 comprises a response processor 152 responsible for processing and identifying the user's responses to the voice menu options. The response processor 152 can be arranged to invoke at least one further voice application or to direct the user to, for example, an automated assistant 154 or a human assistant 156 via a router 158 according to the responses of the user to the output menu options. The automated assistant 154 may take the form of at least one further voice application or any other form of automated assistance.

It will be appreciated from FIG. 1 that the voice applications are indicated as being expressed in VoiceXML. However, the voice applications may be expressed or realised in any other suitable form.

Although the embodiment described above uses the identification data 114 as an index to retrieve a corresponding user profile from the user profiles database 120, embodiments are not limited to such an arrangement. Embodiments can be realised in which data derived from the identification data 114 is used as such an index. The identification data may be subjected to preprocessing in the form of, for example, a hashing algorithm, to arrive at an index suitable to access the user profiles database 120.

The above communication arrangement 100 has been described using a generic reference to a communication network 106. Embodiments of such a communication network 106 may take the form of any communication network such as, for example, the Internet, a wired or wireless LAN, PSTN or mobile telephone network or any other type of network supporting communications. The generic reference to communication network 106 also encompasses a cable connection used to couple the communication equipment 102 to the service platform 104.

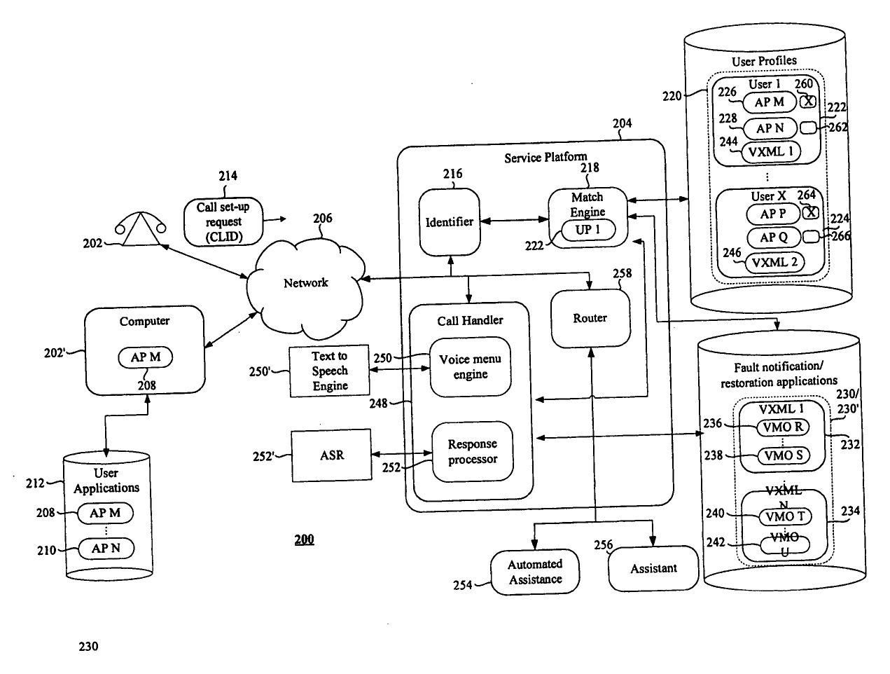

Although the communication arrangement 100 described with reference to FIG. 1 indicates that the communication equipment 102 is responsible for both executing the applications 108 to 110 and supporting the communications with the service platform 104, arrangements can be realised in which such functions are separated. For example, if the communication equipment 102 is realised in the form of a computer that does not support telephony, the communications with the service platform 104 can be supported using a telephone such as is described below with reference to FIG. 2.

The communication arrangement 100 above has been described with reference to the identification data 114 being associated with a user. However, other arrangements can be realised such as, for example, arrangements in which the identification data 114 is associated with the communication equipment 102, a particular program or service rather than with any specific user.

Referring to FIG. 2, there is shown a computer aided telephony arrangement 200 that is a telephony based embodiment of the more general communication arrangement 100 shown in and described with reference to FIG. 1.

The computer aided telephony arrangement 200 allows a caller (not shown) to communicate, using a telephone 202, with a computer aided telephony system 204 via a communication network 206.

The caller has access to a computer 202′ that allows the user to access a number of applications 208 to 210 stored on, for example, an HDD 212. The computer 202′ is illustrated as executing a first application 208. The telephone 202 can be any type of telephone such as, for example, a POTS, a VoIP phone, a wireless telephone or any other type of telephone or communication device. The computer 202′ can be used to access at least one service in addition to or as an alternative to at least one application such as at least one of the applications 208 to 210.

The user of the computer 202′ can obtain assistance relating to any or all of the applications 208 to 210 or services accessible to the user of that computer 202′. To obtain any such assistance, the telephone 202 is used to establish a call with the computer aided telephony system 204. Identification data 214 that uniquely identifies at least one of the user and the telephone 202 or, preferably, both, is transmitted to the computer aided telephony system 204 as part of the communication set up protocol. The identification data can comprise calling line identification data (CLID), dialed number identification service attribute values (DNIS), Calling Number Identification (CNI), AIN equipment or services or any other telephony identification data or identification data associated with the user or equipment accessible to or used by the user. However, any such identification data 214 could be transmitted to the computer aided telephony system 204 at some other convenient time.

The computer aided telephony system 204 comprises an identifier 216 that extracts the identification data 214 from any communication exchange with the telephone 202. The identifier 216 forwards the identification data 214, or data derived therefrom, to a match engine 218 that uses the identification data 214 to retrieve, from a user profiles database 220, the user profile associated with the identification data 214 and, in turn, with the user of the telephone 202. It will be appreciated that the match engine 218 is shown as having retrieved or identified a match between the identification data 214 and a user profile 222 stored within the user profiles database 220.

The user profiles database 220 is, for purposes of illustration, shown as comprising at least one user profile such as the user profile 222 matching the identification data 214. It will also be appreciated that a second or further user profile 224, corresponding to a different user, is also illustrated. The user profiles database 220 may comprise any convenient number of user profiles.

Each user profile is arranged to contain an indication of the applications or services accessible to the user via the computer 202′. Taking the first user profile 222 as an example, it can be appreciated that it contains data 226 and 228 respectively identifying the applications 208 to 210 accessible or used by the computer 202′. Therefore, in response to a communication from the telephone 202, it is reasonable to assume that any such communication is related to one of the applications 208 to 210. Alternatively, or additionally, the data 226 and 228 might relate to one or more services associated with the user. In such circumstances, in response to a communication, it may be reasonable to assume that the communication is related to the one or more services.

The match engine 218, in light of the above assumption, also has access to a voice applications database 230 that contains a number of voice applications 232 to 234. The voice applications database 230 may comprise one voice application or more than one voice application according to requirements even though two voice applications 232 and 234 are illustrated. Each voice application 232 to 234 comprises a number of voice menu options. For example, the first voice application 232 comprises voice menu options 236 to 238 but can comprise any convenient or appropriate number of menu options according to known problems or anticipated needs of a caller. Similarly, the other voice application 234 also comprises a number of voice menu options 240 to 242. Each voice application 232 to 234 has been illustrated as comprising respective pairs of voice menu options. However, each voice application 230 to 234 can comprise any appropriate or convenient number of voice menu options.

Each voice application 232 to 234 is arranged to correspond to a respective user profile. It can be appreciated that each user profile 222 to 224 comprises an indication 244 to 246 of a respective voice application. The voice application indications 244 to 246 are used by the match engine 218 as an index to retrieve an appropriate voice application from the voice applications database 230.

The voice menu options can be expressed in many forms such as, for example, text, for processing by a text-to-speech engine, or digitised speech. The voice application menu options are used to output data as part of an interaction with the user via the telephone 202 in an attempt to determine the user's purpose in making the call. Each voice menu option is associated with a respective known fault. The known fault might be associated with an application of the applications 208 to 210 or a service. Therefore, by tailoring the voice applications 232 to 234 according to the contents of the user profiles 222 to 224, the user should have a more focused interaction with the computer aided telephony system 204, that is, the user will be presented with voice menu options that are potentially more relevant to the user than voice menu options presented by a more generic voice application of, or voice interface to, the computer aided telephony system 204. In effect, the user will be presented with one or more menu options or one or more voice applications relating to one or more known faults. In particular embodiments, the known faults will be those associated with at least one program, service or item of equipment associated with the user.

An embodiment can be realised in which a voice application is constructed not only in light of the known problem or problems but also in light of known issues associated with one or more of the applications 208 to 210 or services, accessible via the computer 202′ or other services. For example, application 208 may have a known fault. Therefore, the first voice application 232 associated with the first user profile 222 corresponding to the caller may comprise a voice menu option relating to that fault. It will be appreciated by one skilled in the art that further tailoring the voice applications in such a manner may lead to the computer aided telephony system 204 being able to provide the user with assistance or being able to direct the user to assistance in a more focused manner.

Having identified a voice application such as the first voice application 232 as being relevant to an incoming or established call, the voice application 232 is forwarded to a communication handler 248. The communication handler 248 is responsible for managing the exchange or communication between the user of the telephone 202 and the voice application. In essence, the communication handler 248 is responsible for executing or interpreting, or at least overseeing the execution or interpreting, of the voice application 232. It will be appreciated that executing and interpreting the voice applications are mere examples of actions that can be generally described as invoking or launching.

The communication handler 248 comprises a voice menu engine 250 responsible for outputting audible data representing digitised speech according to the voice menu options contained within a voice application currently being processed. The voice menu engine 250 achieves this by extracting, for example, text, assuming the voice menu options are expressed using text, from the menu options and forwarding the text to a text-to-speech engine 250′ for conversion of the text to speech data.

The communication handler 248 comprises a response processor 252 responsible for processing and identifying the user's responses to the voice menu options. The response processor 252 uses an automatic speech recogniser (ASR) 252′ to process data representing the responses of the user to the voice menu options. The data representing the responses can take the form of DTMF tones or other signals generated using the telephone or other communication equipment or caller articulations that are processed by the ASR. The ASR outputs data to the response processor reflecting the caller's responses to the menu options. The response processor 252 can be arranged to invoke further voice applications or to direct the user to, for example, an automated assistant 254 or a human assistant 256 via a router 258 according to the responses of the user to the output menu options. The automated assistant 254 may take the form of at least one further voice application or any other form of automated assistance.

It will be appreciated from FIG. 2 that the voice applications are indicated as being expressed in VoiceXML, in which case the voice menu engine 250 may be a VoiceXML interpreter. However, the voice applications may be expressed or realised in any other suitable form.

Although the embodiment described above uses the identification data 214 as an index to retrieve a corresponding user profile from the user profiles database 220, embodiments are not limited to such an arrangement. Embodiments can be realised in which data derived from the identification data 214 is used as an index. For example, the identification data may be subjected to preprocessing in the form of, for example, a hashing algorithm, to arrive at an index suitable for use with the user profiles database 220.

The above computer aided telephony arrangement 200 has been described using a generic reference to a communication network 206. Embodiments of such a communication network 206 may take the form of any communication network such as, for example, the Internet, a wired or wireless LAN, a PSTN or mobile communication network or any other type of network supporting telephony communications. The generic reference to communication network 206 also encompasses a cable used to couple the telephone 202 to the computer aided telephony system 204.

The computer aided telephony arrangement 200 above has been described with reference to the identification data 214 being associated with a user. However, other arrangements can be realised such as, for example, arrangements in which the identification data 214 is associated with the computer 202′ or the telephone 202 or a communication protocol associated with the telephone 202 or computer 202′, network or application rather than with any specific user. For example, identification data relating to the computer 202′ such as, for example, an IP address might be used. However, such an embodiment would require the computer aided telephony system 204 to correlate the incoming telephone call with a communication established, or to be established, with the computer 202′.

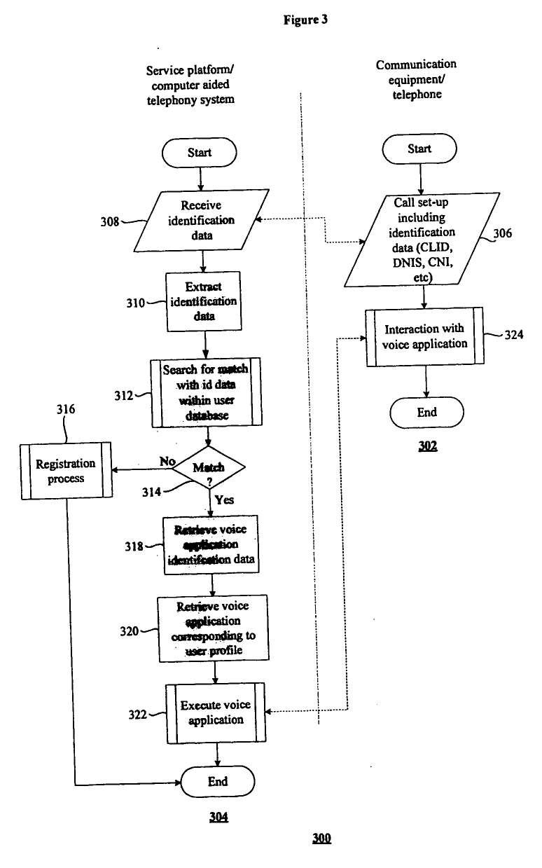

Referring to FIG. 3 there is shown a pair of flow charts 300 depicting the processing undertaken by the above embodiments. A first flow chart 302 of the pair of flow charts 300 relates to processing activities undertaken by equipment such as the telephone 202, computer 202′ or communication equipment 102 used by a user or a caller. A second flow chart 304 illustrates the processing undertaken by the service platform 104 or computer aided telephony system 204. The flow charts will be described with reference to FIG. 2. However, the flow charts 300 are equally applicable to the communication arrangement shown in and described with reference to FIG. 1.

At step 306, the caller establishes or at least instigates a call to the computer aided telephony system 204. The call will be instigated in response to the user identifying a fault associated with a program, service or equipment used by or accessible to the user. Step 306 also includes forwarding identification data such as, for example, the CLID, DNIS attribute values, CNI, AIN data or other identification data. The call set up data, including the identification data, is received at the computer aided telephony system 204 at step 308. The identification data is extracted or identified at step 310 and forwarded to the match engine 218. A search is performed at step 312 to determine whether or not the user profiles database 220 contains a user profile matching the extracted identification data. The determination is made at step 314 as to whether or not such a match exists. If it is determined that such a match does not exist, processing continues at step 316 where the caller is invited to take part in a registration process to collate data from which an appropriate user profile can be constructed. If the determination at step 314 is that a user profile corresponding to the extracted identification data does exist, the voice XML indication contained within the appropriate user profile is retrieved or identified at step 318 and used, at step 320, to retrieve a voice application corresponding to the user profile. The voice application is executed at step 322 which invariably involves an exchange or interaction with the caller as indicated by the process shown at step 324. The voice application is arranged to output data notifying the user of the fault. Additionally, the voice application can be arranged to also request the user to indicate whether or not they wish to receive an automatic notification when the fault has been corrected by, for example, pressing a key and detecting the corresponding DTMF tone or replying using an utterance and identifying the response using the automatic speech recogniser 252′.

Returning to the registration process undertaken at step 316, the details relating to the applications 208 to 210, services or equipment used or accessible by the user are collated. Any such collation can be achieved in a number of ways. For example, the caller could be directed to a web page that has an embedded executable entity, such as an applet, ActiveX component or the like, responsible for identifying the application(s) 208 to 210, service(s) and equipment used by or accessible to the computer 202′. As a refinement, the user can be presented with the list applications, services or equipment identified by the executable entity and requested to select from such a list of those applications to be registered with the computer aided telephony system 204 as being of interest.

Although the above embodiments make reference to applications, services or equipment, it will be appreciated that they are not limited to constructing a user profiles database relating to applications, services or equipment. Also, applications are merely species of the more generic class known as “programs”. Also, it will be appreciated that the service platform 104 and the computer aided telephony system 204 are realisations of a communication system or at least part of such a system.

The user profiles databases 120 and 220 and the voice applications databases 130 and 230 have been shown as separate databases. However, embodiments can be realised in which the databases are combined. For example, each user profile within the user profiles databases 120 and 230 could be arranged to contain the voice applications themselves rather than merely indexes that are used to access such voice applications.

Embodiments can be realised in which a menu option can be presented to a caller or user to allow them to run the registration process described with reference to step 316 to update the programs, services or equipment registered with the service platform 104 or computer aided telephony system 204 as being associated with the caller or user.

It will be appreciated that embodiments of the present invention can be realised in the form of hardware, software or a combination of hardware and software. Accordingly, the various elements of the service platform 104 or computer aided telephony system 204 can be realised using software running on a generic platform.

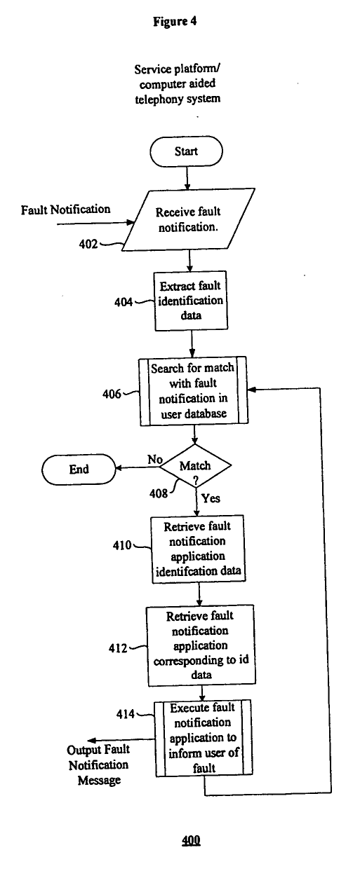

Referring to FIG. 4, there is shown a further flow chart 400 of the operation of a communication system, that is, service platform or computer aided telephony system, according to an embodiment. The embodiment will be described with reference to FIG. 2. At step 402, the computer aided telephony system 204 receives a notification of a fault. The notification of the fault might relate to a service, program, equipment or anything else. The fault notification preferably comprises fault identification data, which is extracted from the fault notification at step 404. The fault identification data provides an indication of the service or thing associated with the fault or affected by the fault. A search is performed, at step 406, for a match with the fault identification data in the user profiles database 220 to identify those users, if any, affected, or potentially affected, by the fault. A determination is made, at step 408, as to whether or not such a match was located. If a match relating to the fault notification is not found within the user profiles database, processing is terminated since none of the users are affected by the fault. However, if the determination at step 408 is such that there is at least one user affected by the fault, further identification data corresponding to a fault notification application is extracted from the user profile corresponding to the match at step 410. The further identification data is used, at step 412, to retrieve a fault notification application from the fault notification applications database 230. The fault notification application is executed at step 414, which causes the user corresponding to the user profile identified above to receive a notification associated with the fault. Thereafter, processing resumes at step 406.

The fault notification application can be, for example, a VoiceXML application that is arranged to place a call to the user and, in response to the user answering the call, to output audio data relating to the fault. Alternatively, or additionally, the fault notification application can be arranged to communicate notification of the fault to the identified user in some other manner. For example, an e-mail describing the fault can be sent to the user. The e-mail may provide a full description of the fault or, for example, may comprise a hyperlink that will take the user to a web page providing a complete description of the fault.

Optionally, the fault notification application may provide the user with the option of making a registration relating to whether or not they wish to be notified of the correction of the fault. Again, such an interaction with the user can be by way of a voice application. Alternatively, or additionally, such an interaction can be via a web page. An arrangement for such registration is described later.

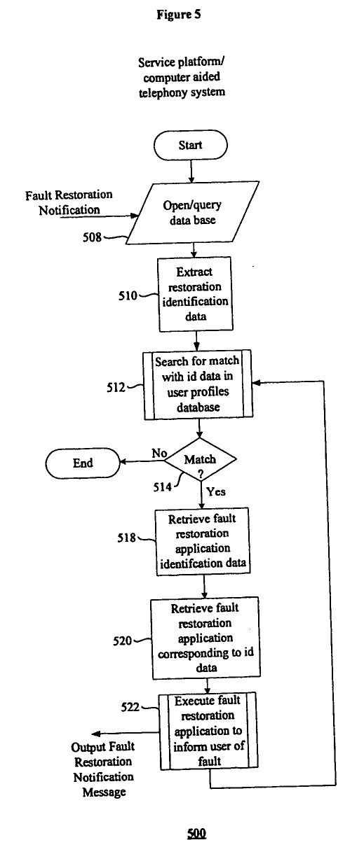

Referring to FIG. 5, there is shown a further flow chart 500 of the operation of a communication system, that is, service platform or computer aided telephony system, according to an embodiment. The embodiment will be described with reference to FIG. 2. At step 502, the computer aided telephony system 204 receives a notification of restoration of a fault. The notification of the restoration might relate to a service, program, equipment or anything else affected by a known fault. The notification preferably comprises fault identification data, which is extracted from the notification at step 504. The fault identification data provides an indication of the service or thing associated with the fault or affected by the fault. A search is performed, at step 506, for a match with the fault identification data in the user profiles database 220 to identify those users, if any, affected, or potentially affected, by the fault. A determination is made, at step 508, as to whether or not such a match was located. If a match is not found within the user profiles database, processing is terminated since none of the users are affected by the fault. However, if the determination at step 508 is such that there is at least one user affected by the fault, restoration identification data corresponding to a fault restoration application is extracted from the user profile corresponding to the match at step 510. The restoration identification data is used, at step 512, to retrieve a fault restoration application from the fault restoration applications database 230′. The fault restoration application is executed at step 514, which causes the user corresponding to the user profile identified above to receive a notification associated with correction of the fault. Thereafter, processing resumes at step 512.

The fault restoration application can be, for example, a VoiceXML application that is arranged to place a call to the user and, in response to the user answering the call, to output audio data relating to the restoration of the fault. Alternatively, or additionally, the fault restoration application can be arranged to communicate notification of the restoration of the fault to the identified user in some other manner. For example, an e-mail describing the restoration of the fault can be sent to the user. The e-mail may provide a full description of the cause of the fault and its restoration or, for example, may comprise a hyperlink that will take the user to a web page providing such a complete description.

It will be appreciated that it may be considered to be relatively burdensome, from a processing overhead perspective, to search through and notify every user potentially having an interest in the fault or the restoration of the fault. This follows, at least in part, from assuming that some users will be unaware of the fault. Therefore, if normal service is resumed before such users become aware of the fault, there seems to be little point in notifying them of the occurrence of the fault. Accordingly, each user profile comprises at least one flag that can be set or reset. The first user profile 222 is shown as having at least one such flag 260. It can be seen that the flag 260 is shown as having been set. It will be appreciated that the set flag 260 is shown as being associated with one of the applications 226. Embodiments can be realised in which each application within a user profile has an associated flag. By way of example, it can be appreciated that the other application 228 also has a corresponding flag 262, which is not set or has been reset. Also, it can be appreciated that the second user profile 224 is also shown as having a pair of flags 264 and 266 corresponding to respective applications. Again, for the purposes of illustration, one of those flags 264 is shown as having been set thereby providing an indication that the user corresponding to the user profile 224 is interested in receiving notification of restoration of the fault associated with the corresponding application AP P.

For completeness, flags corresponding to those described above have also been included in the user profiles 122 and 124 described with reference to FIG. 1.

The flags are set or reset according to whether or not the user provides an indication that they wish to receive notification of the correction of the fault when interacting with the voice applications such as, for example, as in steps 322 and 324 described above with reference to FIG. 3. Therefore, an embodiment can be realised in which the searching step 512 described with reference to FIG. 5 only returns an indication of a match if a user profile has a set flag. This embodiment has the advantage that only those users who have expressed an interest in receiving a notification of the fault restoration receive such a notification.

1. A communication system comprising:
an identifier arranged to process identification data associated with a communication; and
a communication handler arranged to access a data base to invoke at least one voice application arranged to provide assistance in relation to a respective fault responsive to identification data; and the data base configured to comprise the at least one voice application related to the respective fault.

2. A communication system as claimed in claim 1 in which the data base is configured to comprise the voice application in response to the respective fault being associated with at least one program accessible via user equipment such that the voice application provides support in relation to the respective fault.

3. A communication system as claimed in claim 1, in which the communication is a telephone call.

4. A communication system as claimed in claim 3 in which the identification data comprises at least one of Calling Line Identification Data (CLID), dialed Number Identification Service attribute values (DNIS), Calling Number Identification (CNI) or any other telephony identification data or identification data associated with a user, equipment or software accessible to or used by the user.

5. A communication system as claimed in claim 1 in which the communication comprises a data communication having at least one data packet.

6. A communication system as claimed in claim 5 in which the at least one data packet comprises the identification data.

7. A communication system as claimed in claim 6 in which the identification data comprises network data.

8. A communication system as claimed in claim 7 in which the network data comprises an Internet Protocol address.

9. A communication system as claimed in claim 1 in which the at least one voice application comprises at least a one menu option associated with the respective fault.

10. A communication system as claimed in claim 9 in which the at least one voice application comprises a plurality of menu options associated with the respective fault.

11. A communication system as claimed in claim 9 in which the at least one voice application comprises a plurality of menu options associated with respective faults of a plurality of faults including the respective fault.

12. A communication system as claimed in claim 9 comprising a plurality of voice applications each comprising a respective menu option; each voice application being associated with a respective fault of a plurality of faults including the respective fault.

13. A data processing method comprising:
creating, in at least one voice application, at least one menu option associated with at least one known fault;
associating user identification data with the voice application to access the voice application in response to receiving the identification data; and the user identification data being derived from communication data associated with the user.

14. A data processing method as claimed in claim 13 comprising configuring the voice application such that the at least one menu option relates to the known fault and in which the known fault is associated with a program, item of equipment or service associated with a user.

15. A data processing method as claimed in claim 13 comprising creating the at least one menu option such that it comprises data relating to instructions to effect a predetermined action to obtain assistance in relation to the at least one known fault.

16. A data processing method as claimed in claim 15 in which creating the at least one menu option comprises creating a plurality of menu options such that each menu option of the plurality of menu options relates to a respective known fault of a plurality of faults.

17. A data processing method as claimed in claim 13 in which creating, in at least one voice application, at least one menu option comprises configuring a plurality of voice applications associated with at least one respective fault of a plurality of known faults associated with the at least one program.

18. A computer-readable medium storing instructions which, when executed by a processor, cause the processor to implement the data processing method as claimed in claim 13.

19. A communication system comprising:
means for processing identification data associated with a communication; and
means, responsive to the identification data, for accessing a data base to invoke at least one voice application arranged for providing assistance in relation to a respective fault;
the data base having been configured to comprise the at least one voice application related to the respective fault.
